(19) United States
(12) Patent Application Publication
(10) Pub. No.: US 2012/0162086 A1
(43) Pub. Date: Jun. 28, 2012

(54) CHARACTER INPUT METHOD AND APPARATUS OF TERMINAL

(75) Inventors: Bong Jae Rhee, Suwon-si (KR); Wailing Lee, Suwon-si (KR)

(73) Assignee: SAMSUNG ELECTRONICS CO., LTD., Suwon-si (KR)

(21) Appl. No.: 13/336,278

(22) Filed: Dec. 23, 2011

(30) Foreign Application Priority Data
Dec. 27, 2010 (KR) 10-2010-0135207
May 3, 2011 (KR) 10-2011-0041869

(51) Int. Cl. G06F 3/02

(52) U.S. Cl. 345/171; 345/168

(57) ABSTRACT

A character input method and apparatus for a terminal. The character input method includes displaying a main keypad including a plurality of main keys in text input mode. The method also includes entering, when a touch is detected at one of the main keys, a character assigned to the main key at which the touch is made. The method further includes displaying a sub keypad around the main key, the sub keypad including a plurality of sub keys assigned characters combinable with the entered character. The method also includes entering, when the touch is dragged to one of the sub keys, the character assigned to the sub key to which the touch is dragged. The character input method and apparatus of the present disclosure are advantageous for the user to input characters using the main and sub keypads displaying characters combinable with each other.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Dec. 27, 2010 and assigned Serial No. 10-2010-0135207 and to a Korean Patent Application filed in the Korean Intellectual Property Office on May 3, 2011 and assigned Serial No. 10-2011-0041869, the contents of which are herein incorporated by reference.

### TECHNICAL FIELD

The present disclosure relates to a portable terminal and, in particular, to a character input method and apparatus for use in the terminal.

### BACKGROUND

Typically, a terminal integrates various supplementary functions that are provided in combination with each other. The terminal is provided with at least one input device, such as a keyboard and mouse, to facilitate manipulation of the functions, but such an input device causes a portability problem and occupies space unnecessarily with additional maintenance burden. In order to overcome these problems, many recent terminals are equipped with a touchscreen in place of the conventional keyboard and/or mouse. The touchscreen-enabled terminal is configured to display a set of character keys on the touchscreen in text input mode. The terminal detects a touch placed on the touchscreen so as to receive the character of a key to which the touch is made. As mobile terminals evolve with more advanced technologies, touchscreen-assisted character input is in common use.

However, the onscreen keypad of the touchscreen-enabled terminal in which the character keys are arranged in a predetermined pattern is likely to diminish the user convenience. For example, the key arrangement of the keypad can make it difficult to place the touch repeatedly in order to input the user-intended characters in sequence. This problem becomes worse especially when the user attempts to input characters arranged far apart from each other. As a consequence, the cumbersome key combinations cause user inconvenience.

There is therefore a need of a method for facilitating character input for the touchscreen-enable terminal.

### SUMMARY

To address the above-discussed deficiencies of the prior art, it is a primary object to provide a character input method for a terminal. The method includes displaying a main keypad including a plurality of main keys in text input mode. The method also includes entering, when a touch is detected at one of the main keys, a character assigned to the main key at which the touch is made. The method further includes displaying a sub keypad around the main key, the sub keypad including a plurality of sub keys assigned characters combinable with the entered character. The method still further includes entering, when the touch is dragged to one of the sub keys, the character assigned to the sub key to which the touch is dragged.

Preferably, the character input method of the present disclosure further includes hiding, when the touch is released at a key or dragged outside of the sub keypad, the sub keypad on the main keypad.

In accordance with another aspect of the present disclosure, a character input apparatus of a terminal is provided.

The apparatus includes a touchscreen configured to display a main keypad including a plurality of main keys in text input mode. The apparatus also includes a control unit configured to enter, when a touch is detected at one of the main keys, a character assigned to the main key at which the touch is made, display a sub keypad around the main key, the sub keypad including a plurality of sub keys assigned characters combinable with the entered character, and enter, when the touch is dragged to one of the sub keys, the character assigned to the sub key to which the touch is dragged.

Preferably, the control unit hides, when the touch is released at a key or dragged out of the sub keypad, the sub keypad on the main keypad.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of the terminal according to an embodiment of the present disclosure;

FIG. 2 is a flowchart illustrating a method for inputting characters in a terminal according to an embodiment of the present disclosure; and

FIGS. 3, 4, 5A to 5E, 6A to 6F, 7A to 7D, 8, 9, 10, 11A, 11B, and 12A to 12D are diagrams illustrating instances of the execution screen of the text input mode according to an embodiment of the present disclosure.

### DETAILED DESCRIPTION

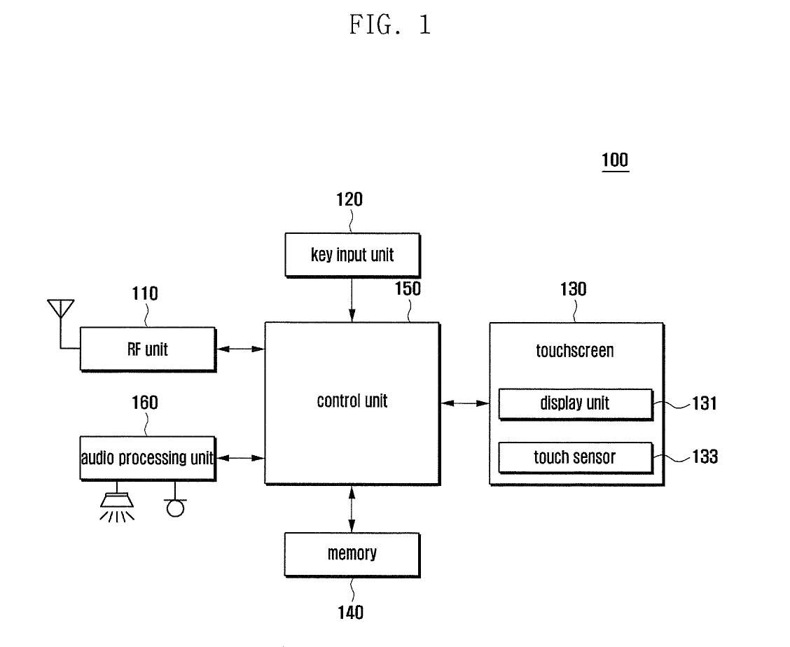

FIGS. 1 through 12D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

In the following description, the term “main keypad” means a soft keypad (i.e. virtual keypad) displayed in text input mode. The term “main key” means a soft key included in the main key pad. That is, the main keypad is composed of a plurality of main keys arranged in a predetermined pattern. Each of the main keys is assigned at least one character.

In the following description, the term “sub keypad” means a soft keypad displayed temporarily in the text input mode. The term “sub key” means a soft key included in the soft keypad. That is, the sub keypad includes at least one sub key. The sub keypad with at least one sub key is configured to be displayed around the main key. Here, the sub keypad can be configured differently or identically dependent on the main key around which the sub keypad is displayed. Each the sub key is assigned at least one character.

In the following description, the term “touch” means a gesture in which the user makes a contact on the touchscreen especially with a finger. The term “drag” means a gesture in which the user moves the finger while maintaining contact on the touchscreen. The term “drop” means a gesture in which the user releases the contact from the touchscreen.

FIG. 1 is a block diagram illustrating a configuration of the terminal according to an embodiment of the present disclosure. In the embodiment of FIG. 1, the description is directed to a mobile terminal.

As shown in FIG. 1, the terminal 100 includes a Radio Frequency (RF) unit 110, a key input unit 120, a touchscreen 130, a memory 140, a control unit 150, and an audio processing unit 160.

The RF unit 110 is responsible for the radio communication of the terminal 100. The RF unit 110 includes an RF transmitter for up-converting and amplifying a signal to be transmitted and an RF receiver for low noise amplifying and down-converting a received signal.

The key input unit 120 is provided with a plurality of function keys for setting and executing the assigned functions.

The touchscreen 130 includes a display unit 131 and a touch sensor 133. The display unit 131 displays the operation state of the terminal 100. The display unit 131 is implemented with a video output device such as a Liquid Crystal Display (LCD) along with a video output device controller, a memory for storing video data, and video display devices. The touch sensor 133 detects a touch made on the display unit 131. The touch sensor 133 is mounted on the display unit 131 and includes a touch detector (not shown) and a signal converter (not shown). The touch detector detects the displacement of physical quantity, e.g. resistance and capacitance, to determine the occurrence of a touch. The signal converter converts the displacement of the physical quantity to a touch signal.

The memory 140 can include program and data memories. The program memory stores programs for controlling the general operations of the terminal 100. In an embodiment of the present disclosure, the program memory can store the programs related to the execution of the text input mode. The data memory stores the data generated by the programs. In an embodiment of the present disclosure, the memory 140 can store the main keypad and sub keypad for use in text input mode. The memory 140 also can store the information on whether to combine a character with other characters selectively.

The control unit 150 is responsible for controlling the overall operations of the terminal. The control unit 150 includes a data processing unit having a transmitter for encoding and modulating the transmit signal and a receiver for demodulating and decoding the receive signal. The data processing unit includes a modem and a codec. The codec includes a data codec for processing packet data and an audio codec for processing audio signals including voice. The control unit 150 can receive a touch signal from the signal converter to detect a touch, drag, and drop made on the touchscreen 130.

The control unit 150 controls such that the main keypad having a plurality of main keys is displayed in the text input mode. If a touch is detected at one of the main keys, the control unit 150 inputs the character assigned to the corresponding key. The control unit 150 can control such that the corresponding character is displayed. The control unit 150 controls such that the sub keypad having at least one sub key is displayed around the main key according to an embodiment of the present disclosure. Here, the control unit 150 can control such that the sub keypad is displayed overlappingly on the main keypad. If a drag from the main key to a sub key is detected, the control unit 150 inputs another character assigned to the corresponding sub key. If a drop is detected at the main key or the sub key or if a drag to a region outside of the sub keypad is detected, the control unit 150 controls such that the sub keypad disappears according to an embodiment of the present disclosure.

The audio processing unit 160 is responsible for outputting the received audio signal output by the audio codec of the data processing unit through a speaker (SPK) and transferring the transmit audio signal input through a microphone (MIC) to the audio codec of the data processing unit.

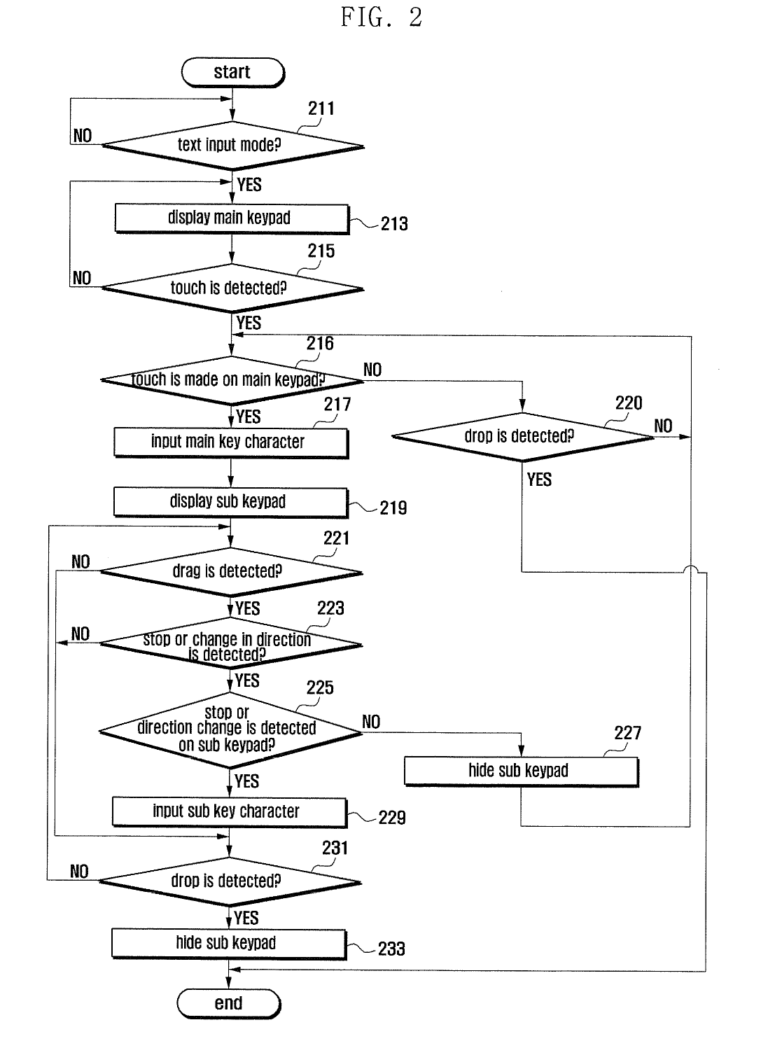

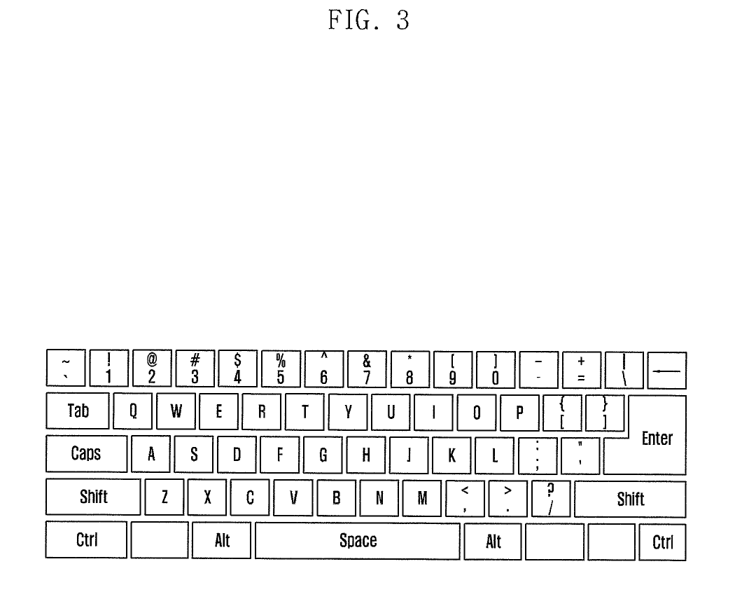

FIG. 2 is a flowchart illustrating a method for inputting characters in a terminal according to an embodiment of the present disclosure. FIGS. 3, 4, 5A to 5E, 6A to 6F, 7A to 7D, 8, 9, 10, 11A, 11B, and 12A to 12D are diagrams illustrating instances of the execution screen of the text input mode according to an embodiment of the present disclosure. The description is directed to embodiments where the terminal is configured to input Chinese characters.

For reference, the Chinese language is composed of around one hundred thousand Chinese characters. For the sake of convenience, the Chinese language is produced in the form of simplified characters and input with Chinese pinyin in the terminal. The Chinese pinyin is a system to transcribe Chinese characters into the Roman alphabet. In the pinyin system, there are 21 “initials” and 36 “finals.” The initial is the consonant that begins a syllable, and the final is the vowel that can be combined with a consonant or used without an initial in the syllable. Table 1 shows the initials, and Tables 2 and 3 show the finals. That is, the pronunciations of all the Chinese characters can be expressed with a combination of a consonant and at least one final or a combination of a combined initial and a plurality of finals as shown in Table 3. There exists the pronunciation only with the final as the initial is omitted. For reference, uei and ui are the same combined final, and iou and iu are the same combined final, and uen and un are the same combined final.

TABLE 1

| Initials | Pinyin | | | | |
|---|---|---|---|---|---|
| Bilabial | b | p | m | | |
| Labiodental | | | | f | |
| Coronal | d | t | n | | |
| | l | | | | |
| Velar | g | k | h | | |
| Palatal | j | q | x | | |
| Retroflex | zh | ch | sh | | r |
| Alveolar | z | c | s | | |

TABLE 2

| Final | | Pinyin | | | | | | |
|---|---|---|---|---|---|---|---|---|
| Normal | Single Final | a | o | e | i | u | ü | |
| Finals | Double Final | ai | ei | ao | ou | | | |
| | Final with | an | en | ang | eng | ong | | |
| | consonant | | | | | | | |
| | Retroflex | er | | | | | | |
| | Final | | | | | | | |
| Combined Finals | | ia | ie | iao | iu | ian | in | iang |
| | | ing | iong | | | | | |
| | | ua | uo | uai | ui | uan | un | uang |
| | | ueng | | | | | | |
| | | üe | üan | ün | | | | |

TABLE 3

| | | qích\check{i}yīn | | hék\check{o}uyin | | cuōk\check{o}uyīn | |
|---|---|---|---|---|---|---|---|
| | | I | | u | | ü | |
| | | with | without | with | without | with | without |
| Combined | | initial | initial | initial | initial | initial | initial |
| Finals | | i | yi | u | wu | ü | ü |
| Single | a | Ia | ya | ua | wa | | |
| final | o | | yo | uo | wo | | |
| | e | Ie | ye | | | üe | yue |
| Double | ai | | | uai | wai | | |
| final | ei | | | u(e)i | wei | | |
| | ao | Iao | yao | | | | |
| | ou | i(o)u | you | | | | |
| Final | an | Ian | yan | uan | wan | üan | yuan |
| followed | en | In | yin | u(e)n | wen | ün | Yun |
| by | ang | Iang | yang | uang | wang | | |
| initial | eng | Ing | ying | ueng | weng | | |
| | ong | Iong | Yong | | | | |

Referring to FIG. 2, in the character input method of the terminal 100 according an embodiment of the present disclosure, the control unit 150 determines whether the terminal 100 operates in text input mode (block 211). In text input mode, the control unit 150 displays the main keypad (block 213). The main keypad includes a plurality of main keys. That is, the control unit 150 displays the main keypad having a plurality of main keys arranged in a predetermined pattern. The control unit 150 assigns at least one character to each main key. Here, the main keypad can be configured in the form of a QWERTY keypad similar to a keyboard. For example, the control unit 150 can display the main keypad having the main keys assigned respective initials and finals as shown in FIG. 3.

If a touch is made on the touchscreen in the state displaying the main keypad, the control unit 150 detects the touch (block 215) and determines whether the touch is made on the main keypad (block 216). That is, the control unit 150 checks the coordinates at which the touch is detected on the touchscreen 130. The control unit 150 determines the main key corresponding to the coordinates.

If i [symbol] is determined that the touch is made on the main keypad at block 216, the control unit 150 inputs the character assigned to the main key corresponding to the coordinates. That is, the control unit 150 selects the main key corresponding to the coordinates at which the touch is made and inputs the character assigned to the selected main key. Next, the control unit 150 displays the sub keypad (219). The sub keypad includes at least one sub key. That is, the control unit 150 displays the sub keypad including at least one of the sub keys arranged in a predetermined pattern. The control unit 150 assigns at least one character combinable with the character of the main key to the respective sub keys.

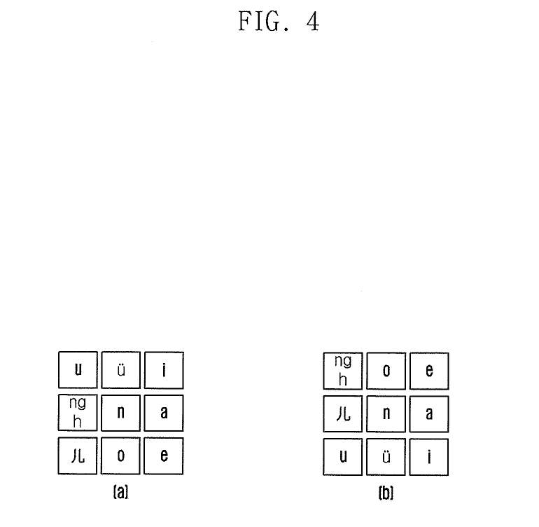

For example, the control unit 150 can display a sub keypad of which each sub key is assigned at least one initial or final as shown in parts (a) and (b) of FIG. 4. The control unit 150 can display the sub keypad in which the sub keys are arranged in 3×3 grid. The control unit 150 can assign the characters of u, ü, i, ng, h, n, a, [symbol] , and e to the sub keys. Here, the control unit 150 can assign ng and h to one sub key. The sub keypad is not limited to the configurations shown in parts (a) and (b) but can be implemented in a different form. Here, [symbol] represents the retroflex final er so as to be able to be presented as r in the state where the main key assigned e is selected. Also, ü can be replaced by v. The control unit 150 displays the sub keypad such that it overlaps the main keypad. The control unit 150 arranges the sub keys around the main key. When at least one main key is assigned a character which is not combinable with the character of the main key, the control unit 150 can inactivate the corresponding sub key or hide the character on the corresponding sub key.

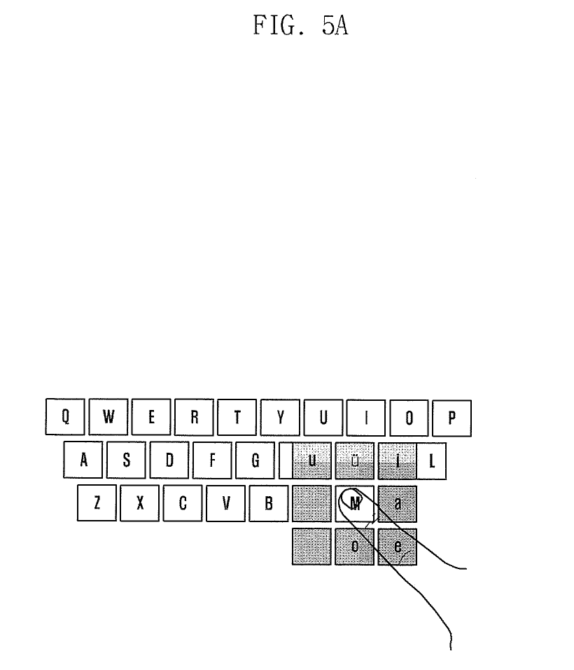

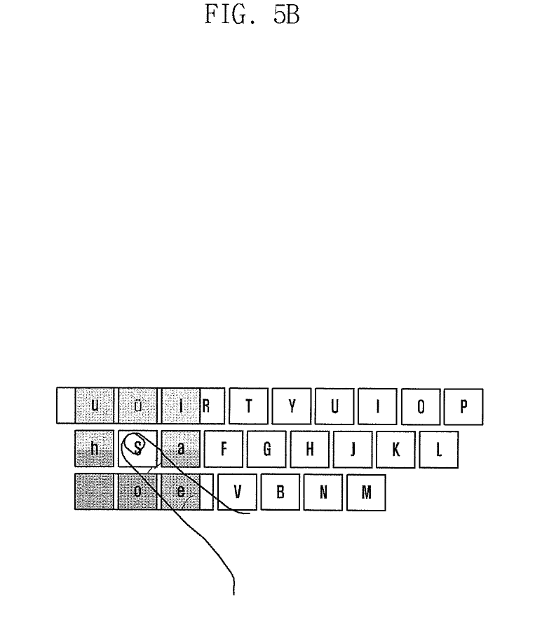

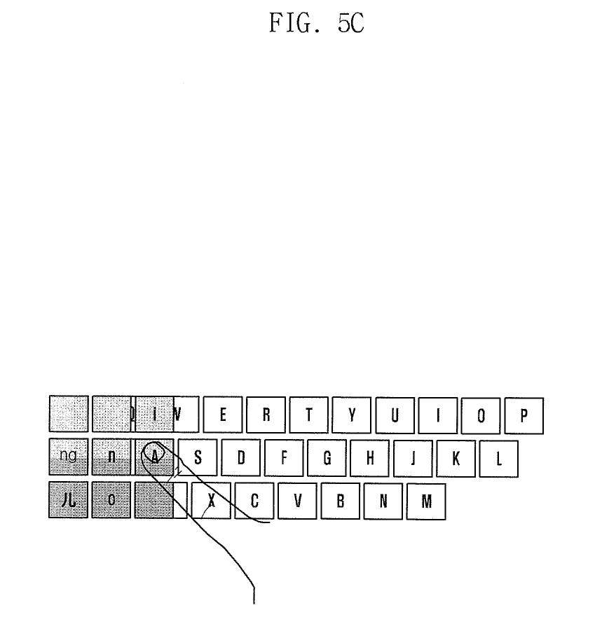

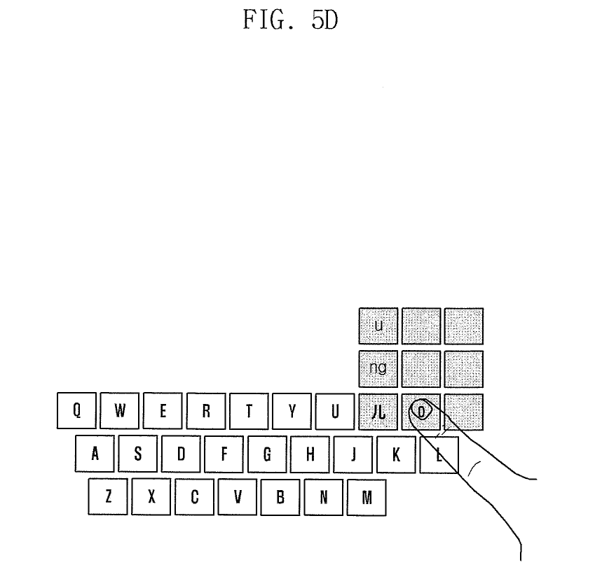

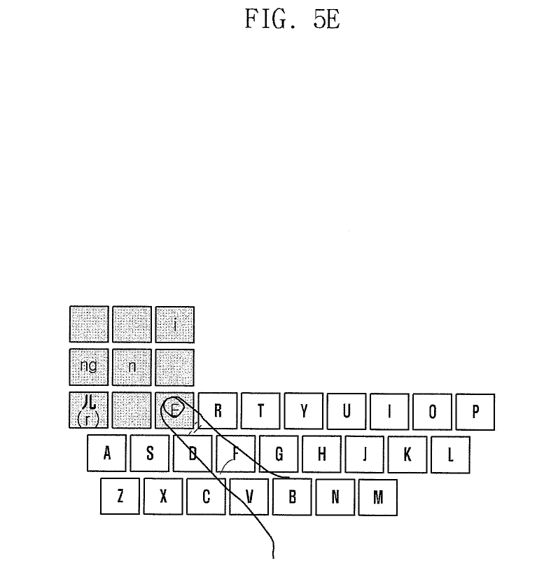

The control unit 150 can arrange the sub keys such that the main key is placed at the center of the sub keypad. For example, if the character of the main key is an initial except z, c, and s, the control unit 150 arranges the sub keys around the main key at the center of the sub keypad and assigns the finals to the sub keys as shown in FIG. 5A. That is, if the character of the main key is one of b, p, m, f, d, t, n, l, g, k, h, j, q, x, and r; the control unit 150 can assign u, ü, i, a, o, and e to the respective sub keys. If the character of the main key is one of the initials z, c, and s; the control unit 150 can arrange the sub keys in order for the main key to be placed at the center of the sub keypad and assign h and finals as shown in FIG. 5B. That is, if the character of the main key is one of z, c, and s; the control unit 150 can assign u, ü, i, h, a, o, and e to the sub keys, respectively.

The control unit 150 can arrange the sub keys such that the main key is placed at a region other than the center of the sub keypad, i.e. edge of the sub keypad. For example, if the character of the main key is the final a, the control unit 150 can arrange the sub keys such that the final a is assigned to a predetermined region on the sub keypad and assigns the finals to the respective sub keys as shown in FIG. 5C. That is, if the character of the main key is a, the control unit 150 can assign i, ng, n, o, and [symbol] to the sub keys. Here, if a and [symbol] cannot be combined with each other, the control unit 150 can inactivate the sub key to which [symbol] is assigned or hide [symbol] on the corresponding sub key on the sub keypad. If the character of the main key is o, the control unit 150 can arrange the sub keys in order for o to be placed at a predetermined region on the sub keypad and assign the finals to the respective sub keys as shown in FIG. 5D. That is, if the character of the main key is o, the control unit 150 can assign u, ng, and [symbol] to the sub keys. If o and [symbol] are not combinable with each other, the control unit 150 can inactivate the sub key to which [symbol] is assigned or hide [symbol] on the corresponding sub key. If the character of the main key is the final e, the control unit 150 can arrange the sub keys in order for e to be placed at a predetermined region on the sub keypad and assign the finals to the respective sub keys as shown in FIG. 5E. That is, if the character of the main key is e, the control unit 150 can assign i, ng, n, and [symbol] to the respective sub keys. Here, the control unit 150 can replace [symbol] for r or further assign r to the sub key to which [symbol] has been assigned already. Although the main key is assigned an initial (e.g. a, o, or e), the control unit 150 can arrange the sub keys such that the main key is placed at the center of the sub keypad.

If a drag is made in the state where the main and sub keypads are displayed on the touchscreen 130, the control unit 130 detects the drag (block 221). The control unit 150 checks the coordinates at the start point of the drag. Afterward, if the drag stops or changes in direction, the control unit 150 detects the stop or direction change (block 223) and determines whether the stop or direction change is detected on the sub keypad (block 225). That is, the control unit 150 determines whether the drag is made to the sub keypad. The control unit 150 checks the coordinates at which the drag has stopped or changed in direction. The control unit 150 also checks whether the coordinates are located in the range of the sub keypad.

If it is determined that the drag has stopped or changed in direction on the sub keypad at block 225, the control unit 150 inputs a character (block 229). That is, the control unit 150 selects the sub key corresponding to the coordinates at which the drag has stopped and inputs the character assigned to the sub key. Afterward, if no drop is detected on the touchscreen 130 (block 231), the control unit 150 returns the procedure to block 221.

If the character of the sub key at which the drag has stopped or changed in direction is h, the control unit 150 inputs h and then can rearrange the sub keys such that the corresponding sub key is placed at the center of the sub keypad. That is, the control unit 150 can rearrange the sub keys such that the h is displayed at the center of the sub keypad. In this manner, when the sub key to which h is assigned is selected on the sub keypad, the sub keys having other finals can be arranged around h.

If the character assigned to the sub key corresponding to the coordinates at which the drag has stopped or changed in direction, the control unit 150 can maintain the character assigned to the corresponding sub key in the sub keypad and reassign characters to the remaining sub keys of the sub keypad as shown in FIG. 5A or 5B. That is, the control unit 150 can inactivate at least one sub key or hide the character assigned to the corresponding sub key on the sub keypad.

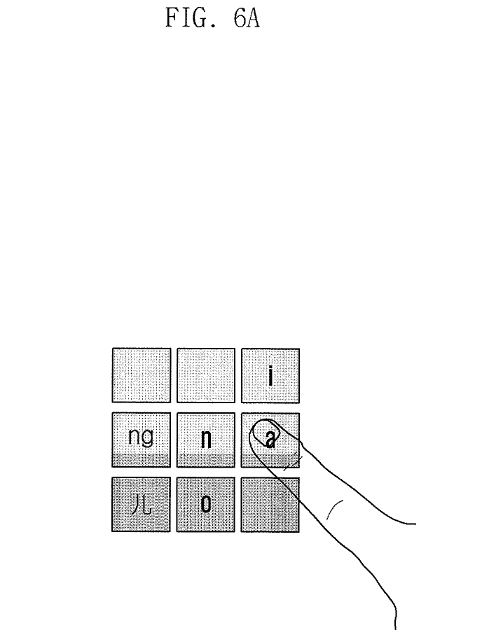

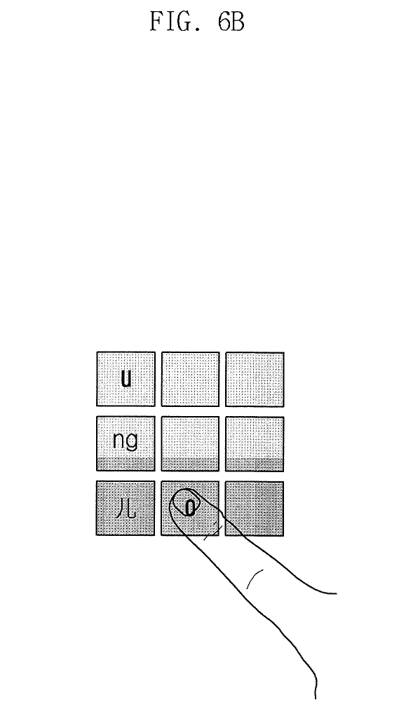

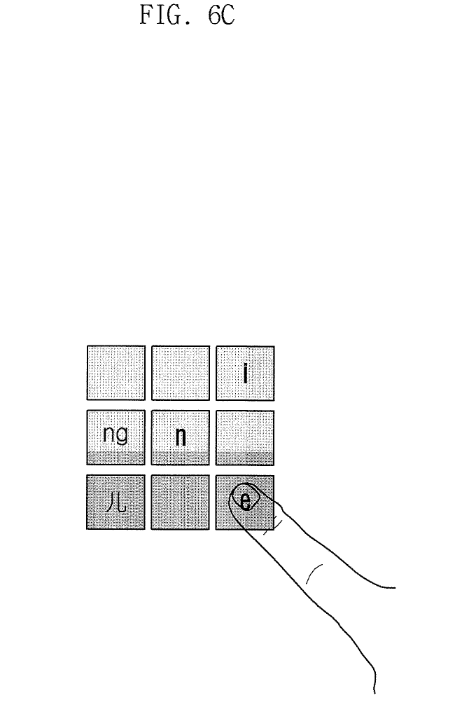

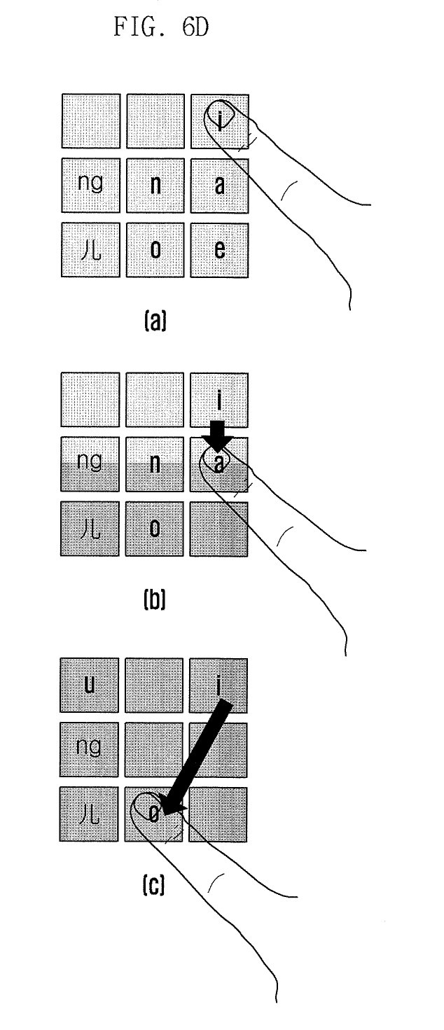

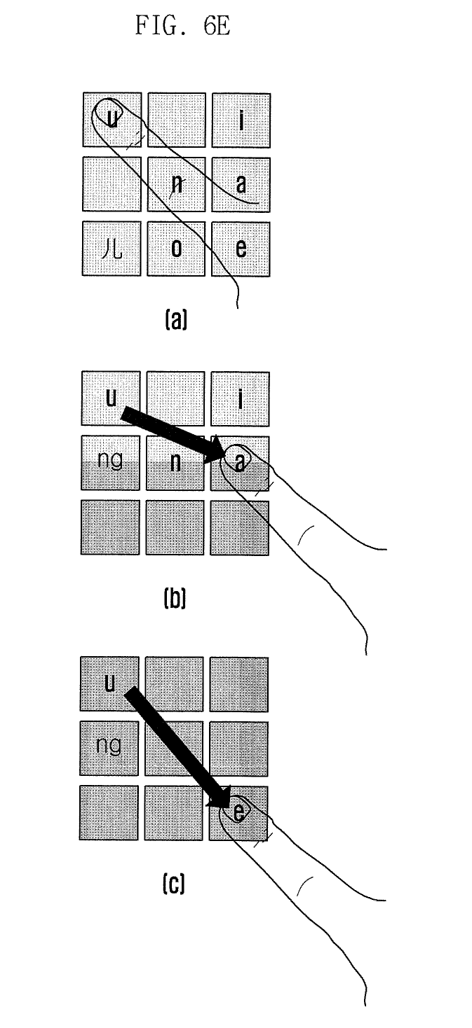

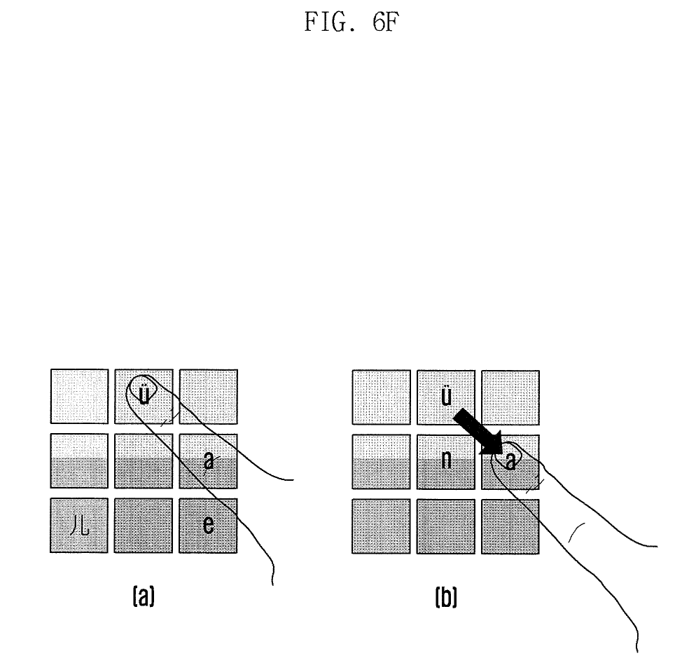

For example, if the drag is made from the main key assigned the initial to the sub key assigned a, the control unit 150 can display the sub key pad as shown in FIG. 6A. That is, the control unit 150 can assign i, ng, n, o, and [symbol] to the respective sub keys. With these sub keys, the control unit 150 can input a, ai, ao, or ang along with the initial. If the drag is made from the main key to which an initial is assigned to the sub key to which o is assigned, the control unit can display the sub keypad as shown in FIG. 6B. That is, the control unit 150 can assign u, ng, and [symbol] to the respective sub keys. With these sub keys, the control unit 150 can input o, ou, or ong along with the initial. If the drag is made from the main key assigned the initial to the sub key assigned e, the control unit 150 can display the sub keypad as shown in FIG. 6C. That is, the control unit 150 can assign i, ng, n, and [symbol] to the sub keys. With these sub keys, the control unit 150 can input e, ei, en, or eng along with the initial.

If the drag is made from the main key assigned the initial to the sub key assigned i, the control unit 150 can display the sub keypad as shown in part (a) of FIG. 6D. That is, the control unit 150 can assign ng, n, a, e, o, and [symbol] to the sub keys. With these sub keys, the control unit 150 can input i, ia, ie, iu, io, in, or ing along with the initial. If the drag is further progressed from the sub key assigned i to the sub key assigned a, the control unit 150 can display the sub keypad as shown in part (b) of FIG. 6D. That is, the control unit 150 can assign i, ng, n, o, and [symbol] to the sub keys. With these sub keys, the control unit 150 can input ia, iao, ian, or iang along with the initial. If the drag is further progressed from the sub key assigned i to the sub key assigned I, the control unit 150 can display the sub key pad as shown in part (c) of FIG. 6D. That is, the control unit can assign u, ng, and [symbol] to the sub keys. With these sub keys, the control unit 150 can input io, iou, or iong along with the initial.

If the drag is made from the main key assigned an initial to a sub key assigned u, the control unit 150 can display the sub keypad as shown in part (a) of FIG. 6E. That is, the control unit 150 can assign i, n, a, e, o, and [symbol] to the sub keys. With these sub keys, the control unit can input u, ua, ue, ui, uo, or un along with the initial. If the drag is further progressed from the sub key assigned u to the sub key assigned a, the control unit 150 can display the sub keypad as shown in part (b) of FIG. 6E. That is, the control unit 150 can assign i, ng, and n to the sub keys. With these sub keys, the control unit can input uai, uan, or uang along with the initial. If the drag is further progressed from the sub key assigned u to the sub key assigned e, the control unit 150 can display the sub keypad as shown in part (c) of FIG. 6E. That is, the control unit 150 can assign ng to one of the sub keys. With these keys, the control unit 150 can input uei, uen, or ueng along with the initial.

If the drag is made from the main key assigned ü, the control unit 150 can display the sub keypad as shown in part (a) of FIG. 6F. That is, the control unit 150 can assign a, e, and [symbol] to the sub keys. With these sub keys, the control unit 150 can input ü, üe, or ün along with the initial. If the drag is further progressed from the sub key assigned ü to the sub key assigned a, the control unit 150 can display the sub keypad as shown in part (b) of FIG. 6F. That is, the control unit 150 can assign n to one of the sub keys. With these sub keys, the control unit 150 can input üan along with the initial. Here, when the drag is further progressed from the sub key assigned ü to the sub key assigned a, the control unit 150 can input üan without additional drag from the sub key assigned a to the sub key assigned n. Also, the control unit 150 can control to input üan when the drag is further progressed from the sub key assigned a to the sub key assign n.

If it is determined that the drag has not stopped or changed in direction on the sub keypad at block 225, the control unit 150 hides the sub keypad (block 227). The control unit 105 controls such that the sub keypad disappears on the main keypad. That is, the control unit 150 displays the main keypad without an overlapping sub keypad. Next, the control unit 150 returns the procedure to block 216. The control unit 150 determines whether the drag has stopped or changed in direction on the main keypad at block 216. That is, the control unit 150 determines whether the drag is made to the main keypad. Here, the control unit 150 determines whether the coordinates at which the drag has stopped or changed in direction are located on the main key pad. If it is determined that the drag has stopped or changed in direction on the main keypad at block 216, the procedure goes to block 217. That is, the control unit 150 inputs the character assigned to the main key corresponding to the coordinates at which the drag has stopped or changed in direction. The control unit 150 inputs the character assigned to the main key in combination with the previously input character. Sequentially, the control unit 150 displays the sub keypad at block 219. The control unit 150 can display the sub keypad around the main key corresponding to the coordinates at which the drag has stopped or changed in direction.

If it is determined at block 216 that the touch or drag has not stopped or changed in direction on the main keypad, i.e. if the touch or drag has stopped or changed in direction outside of the main keypad, the control unit 150 determines whether a drop has occurred outside of the main keypad (block 220). If it is determined that a drop has occurred outside of the main keypad, the control unit 150 returns the procedure to block 211. If it is determined that no drop has occurred outside of the main keypad at block 220, the control unit 150 returns the procedure to block 216.

That is, the control unit 150 can repeat blocks 216 to 229 partially or entirely until a drop event following the touch or drag is detected on the touchscreen. Here, the control unit 150 can change the characters assigned to the sub keys of the sub keypad according to the last input character.

In this way, the control unit 150 can input a plurality of characters in combination with each other. When it is detected that the drag returns onto the same main key or the same sub key, the control unit 150 can input the character assigned to the main key or another character assigned to the sub key.

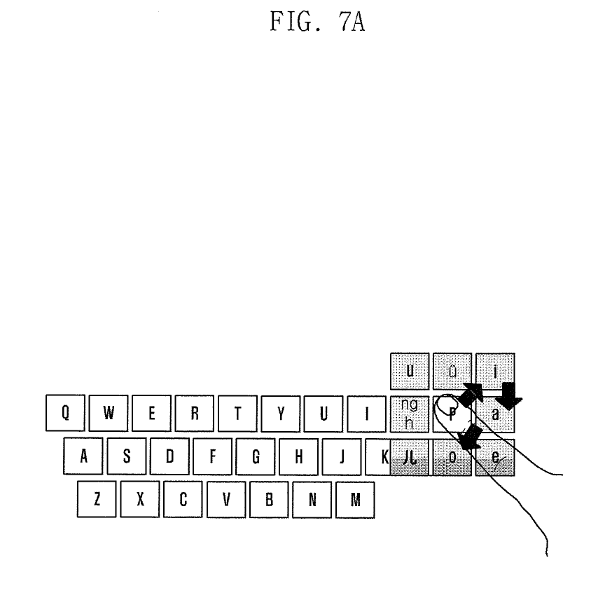

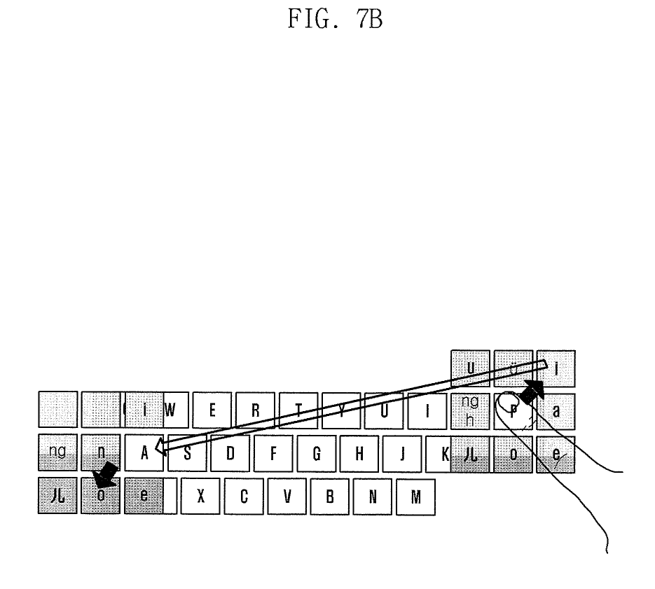

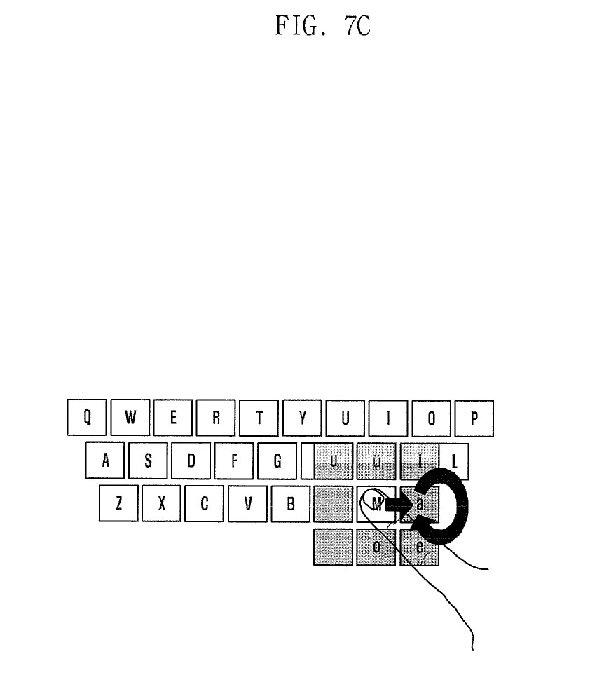

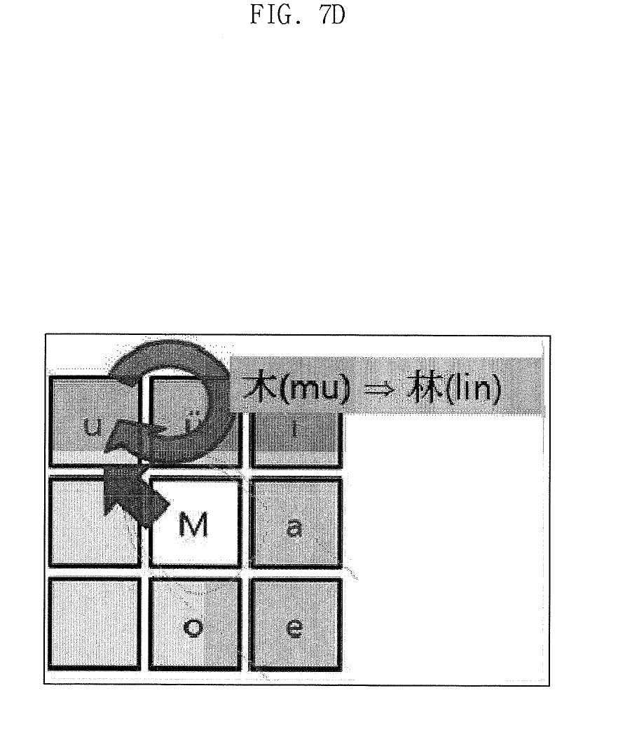

For example, the control unit 150 can input pi'ao representing [symbol] as shown in FIG. 7A. Since [symbol] composed of two syllables and [symbol] composed of one syllable are expressed by the same pinyin, an apostrophe ' is used to discriminate between syllables. If the drag is detected on the sub keypad and the main keypad after the touch is detected at a main key, the control unit 150 can input the initial p and the finals i', a, and o in sequence. Although the apostrophe ', which is used for discriminating between syllables of finals starting with a, o, or e in the Chinese pinyin, is not inserted manually, the control unit 150 can input it automatically. That is, the input of a syllable is completed with the drag-out from the sub keypad, and the next syllable starts with the selection of a main key.

Also, the control unit 150 can input repetitive Chinese characters such as [symbol] (mama) in a simplified way as shown in FIG. 7C. That is, the control unit 150 can input the initial m and the final a in sequence according to the detection of the touch at the main key assigned m and the drag to the sub key assigned a in the sub keypad. If a drag returning to the same sub key is detected, the control unit 150 can control to input the previously input syllable ma again.

The control unit 150 also can input Chinese characters such as [symbol] (lin) and [symbol] (sen) that are formed by repeating the same character [symbol] (mu). That is, the control unit 150 can input the initial m and the final u in sequence according to the detection of the touch at the main key assigned m and the drag to the sub key assigned a in the sub keypad. If a drag returning to the same sub key is detected, the control unit 150 regards this as the double input of the syllable mu so as to input the character [symbol] (lin) formed by doubling [symbol] (mu). If the drag returning to the same sub key is detected one more time, the control unit 150 regards this as the triple input of the syllable mu so as to input the character [symbol] (sen) formed by tripling [symbol] (mu).

The character [symbol] can be input by entering ng according to the pronunciation in a dictionary as well as by entering en or eng. For the initial n, it is possible to enter ng according to a drag from the main key assigned the initial n to the sub key at which ng is replaced by g.

Finally, if a drop is made in the state where the main keypad and the sub keypad are displayed on the touchscreen (231), the control unit 150 detects the drop and hides the sub keypad on the main keypad (233). That is, the control unit 150 displays the main keypad without the overlapping sub keypad. As a consequence, the character input procedure ends.

When a touch is detected at a specific main key of the main keypad displayed on the touchscreen 130, the control unit 150 displays the sub keypad. Afterward, if the drag stops or changes in direction on the main keypad or the sub keypad, the control unit 150 presents at least one candidate word by combining at least one character assigned to the main key and at least one of the characters assigned to the respective sub keys. If a candidate word is selected, the control unit 150 inputs the candidate word. For example, if the main key assigned g and h and the sub keys assigned respective u, a, and [symbol] are selected in sequence, the control unit 150 presents the candidate words of guar and huar. If the word guar or huar is selected, the control unit 150 controls to display the selected word guar or huar.

If a touch is detected at a specific main key of the main keypad on the touchscreen 130 at least one time, the control unit 150 selects and inputs the character assigned to the main key in association with the number of touching times. Next, the control unit 150 displays the sub keypad. If a drag is detected and then stops or changes in direction in the state where the main and sub keypads are displayed on the touchscreen 130, the control unit 150 inputs the character assigned to the key of the sub or main keypad at which the drag has stopped or changed in direction. If a drop event is detected on the touch screen, the control unit 150 hides the sub keypad.

Although the description is directed to a Chinese character input system using pinyin, the present disclosure is not limited thereto. For example, the present disclosure can be applied to the Chinese character input system using Zhuyin fuhao (phonetic symbol). The character input method based on the Zhuyin fuhao is a method to select the key assigned a representative Chinese character among many Chinese characters having the same pronunciation. The Zhuyin fuhao is composed of 21 initials and 38 finals. Table 4 shows the initials, and Tables 5 and 6 show the finals.

TABLE 4

| | Zhuyin | |
|---|---|---|
| Initial | fuhao | Pinyin |
| chóngchúnshēng | [symbol] | b |
| | [symbol] | p |
| | [symbol] | m |
| Bilabial | [symbol] | f |
| Alveolar | [symbol] | d |
| | [symbol] | t |
| | [symbol] | n |
| | [symbol] | l |
| Velar | [symbol] | g |
| | [symbol] | k |
| | [symbol] | h |
| Palatal | [symbol] | j |
| | [symbol] | q |
| | [symbol] | x |
| qiáoshéjiān | [symbol] | zh |
| shēng | [symbol] | ch |
| | [symbol] | sh |
| | [symbol] | r |
| Alveolar | [symbol] | z |
| | [symbol] | c |
| | [symbol] | s |

TABLE 5

| | | Pinyin | |
|---|---|---|---|
| Normal | | Without | With |
| Finals | Zhuyin fuhao | initial | initial |
| Single | [symbol] | a | |
| Finals | [symbol] | o | |
| | [symbol] | e | |
| | [symbol] | ê | |
| | — | yi | (i) |
| | [symbol] | wu | (u) |
| | [symbol] | yu | (ü) |
| Double | [symbol] | ai | |
| Finals | [symbol] | ei | |
| | [symbol] | ao | |
| | [symbol] | ou | |
| Final with | [symbol] | an | |
| consonant | [symbol] | en | |
| | [symbol] | ang | |
| | [symbol] | eng | |
| Retroflex | [symbol] | er | (r) |
| final | | | |

TABLE 6

Pinyin

| Combined | Zhuyin | Without | With |
|---|---|---|---|
| Finals | fuhao | initial | initial |
| qích\check{i}lèi | — [symbol] | ya | (ia) |
| | — [symbol] | yo | |
| | — [symbol] | ye | (ie) |
| | — [symbol] | yai | |
| | — [symbol] | yao | (iao) |
| | — [symbol] | you | (ou, iu) |
| | — [symbol] | yan | (ian) |
| | — [symbol] | yin | (in) |
| | — [symbol] | yang | (iang) |
| | — [symbol] | ying | (ing) |
| hék\check{o}ulèi | — [symbol] [symbol] | wa | (ua) |
| | — [symbol] | wo | (uo) |
| | — [symbol] | wai | (uai) |
| | — [symbol] | wei | (iu) |
| | — [symbol] | wan | (uan) |
| | — [symbol] | wen | |
| | — [symbol] | wang | (uang) |
| | — [symbol] [symbol] | weng | (ong) |
| cuōk\check{o}ulèi | — [symbol] | yue | (ue) |
| | — [symbol] | yuan | (uan) |
| | — [symbol] | yun | (un) |
| | — [symbol] [symbol] | yong | (iong) |

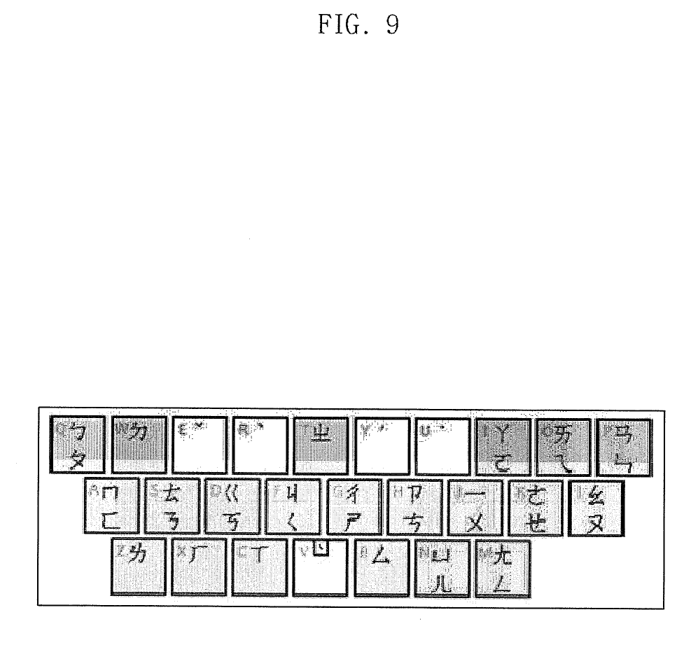

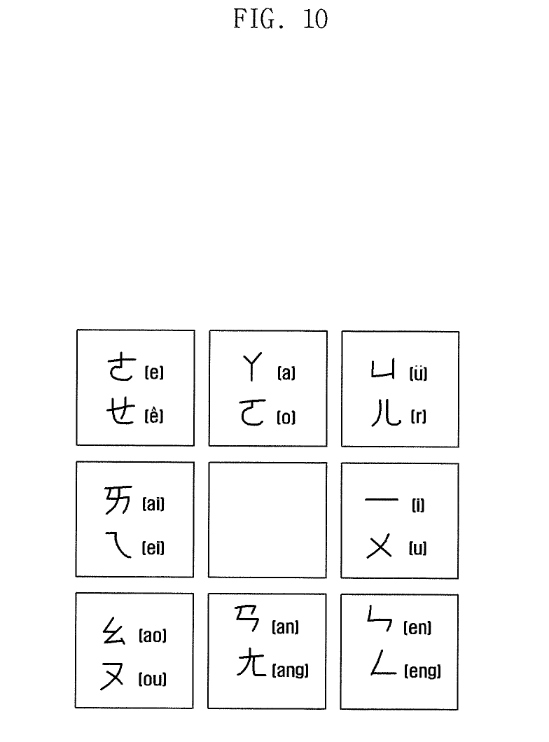

In text input mode, the control unit 150 displays the main keypad having the keys assigned the characters as shown in FIG. 9. If a touch is detected in the state where the main keypad is displayed on the touchscreen 130, the control unit 150 selects the main key at which the touch is detected and inputs the character assigned to the main key. The control unit 150 also displays the sub keypad having the sub keys assigned characters combinable with the character assigned to the selected main key as shown in FIG. 10. For example, the control unit 150 can assign the pairs of characters, (i.e., [symbol] and [symbol] , [symbol] and [symbol] , [symbol] and [symbol] , [symbol] and [symbol] , — and [symbol] , [symbol] and [symbol] , [symbol] and [symbol] , and [symbol] and [symbol] ) to the respective sub keys. Afterward, if it is detected that a drag occurs and then stops or changes in direction on the main keypad or the sub keypad displayed on the touchscreen, the control unit 150 inputs the character assigned to the key of the sub or main keypads at which the drag has stopped or changed in direction. If it is detected that a drag started from a main key returns to the same main key or a drag started from a sub key returns to the same sub key, the control unit 150 inputs the character assigned to the key repeatedly as many as the number of drag returns. If a drop event is detected on the screen, the control unit 150 hides the sub key.

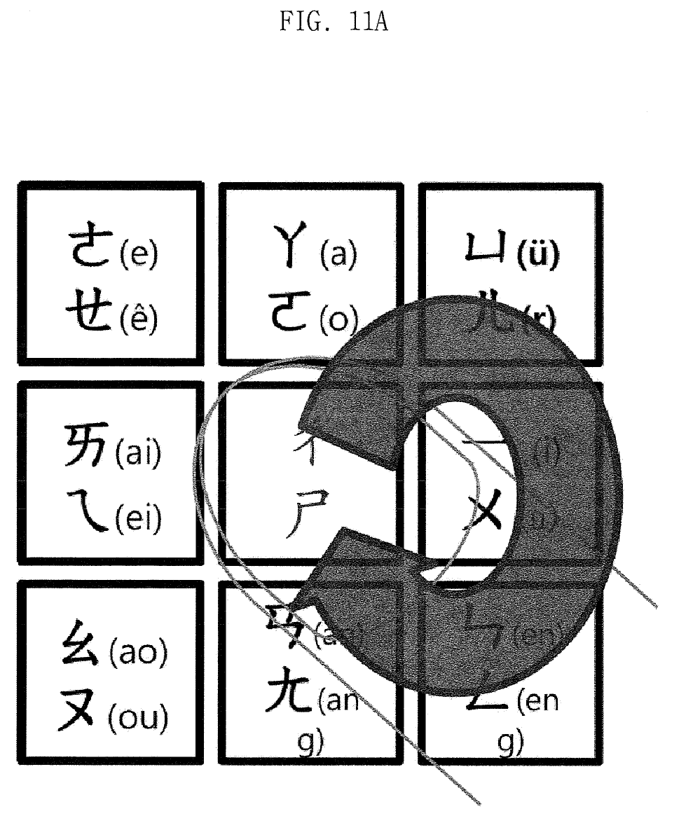

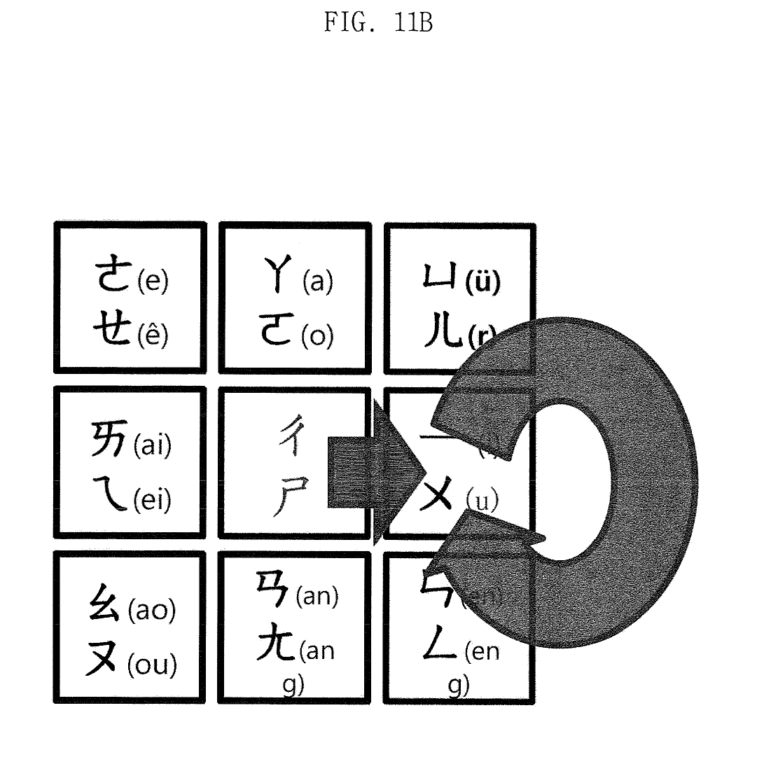

For example, if a touch is made at the main key corresponding to G in the main keypad as shown in FIG. 9 and then the drag-and-return to the main key corresponding to G is made as shown in FIG. 11A, the control unit 150 inputs the character P. When the touch is detected at the main key corresponding to G, the control unit 150 displays the sub keypad as shown in FIG. 11B. Afterward, if the drag is made from the main key corresponding to G to the sub key at its right side and then the drag-and-return is made to the same sub key, the control unit 150 inputs the character [symbol] . As a consequence, a series of characters [symbol] is input.

Although the description is directed to embodiments where the sub keypad is used to input the finals, the present disclosure is not limited thereto. For example, the sub keypad can be configured to input tones. Here, tone refers to the pitch level of sound in pronouncing a Chinese character. There are four tones in pinyin: yinping, yangping, shangsheng, and quseng. When writing Chinese, yinping is marked by -, yangping is marked by /, shangsheng is marked by □, and quseng is marked by \.

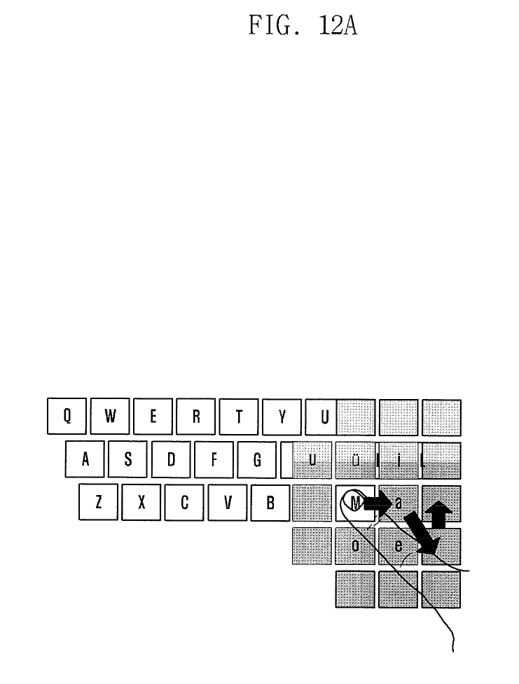

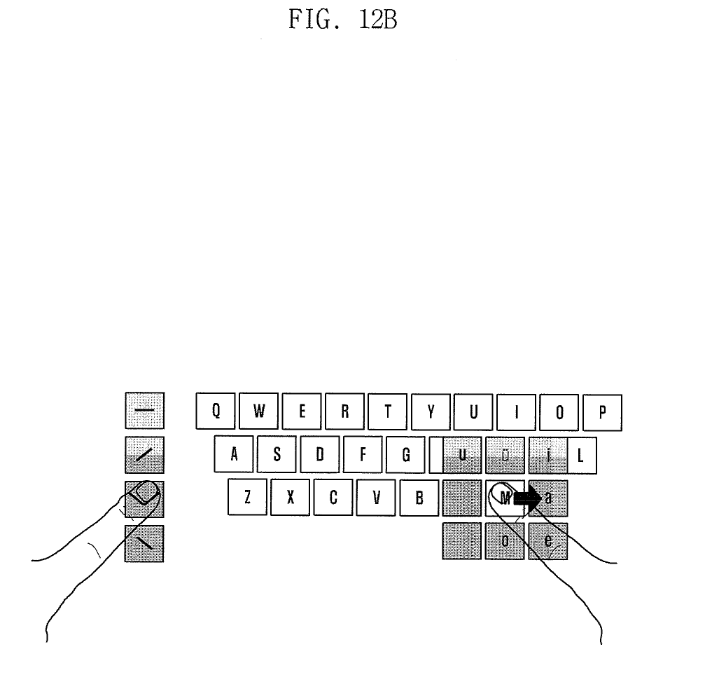

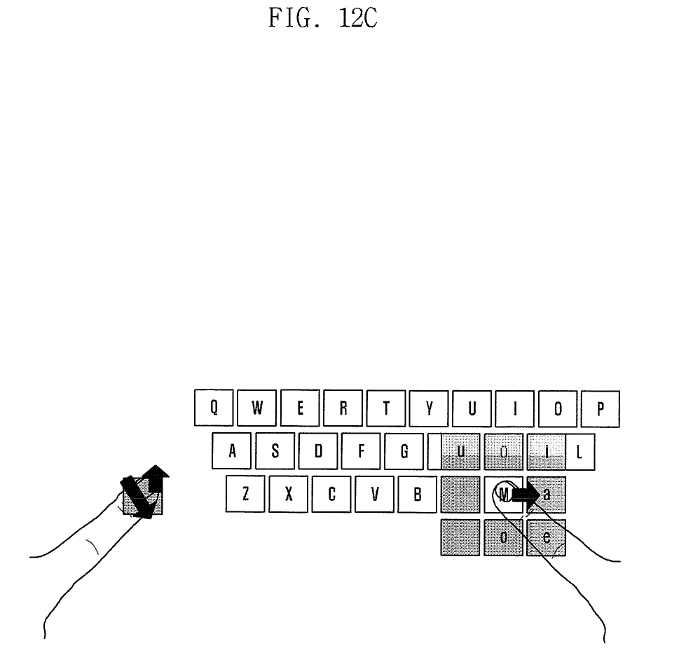

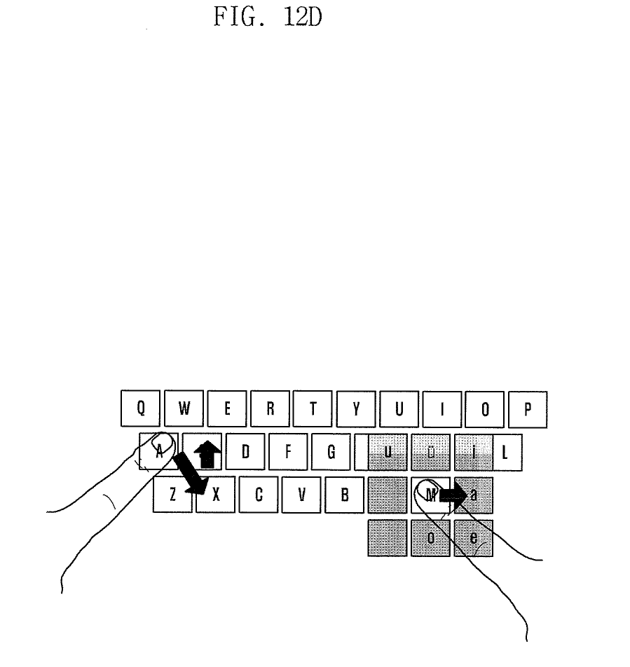

That is, the control unit 150 can display the sub keypad having the sub keys assigned characters and tones as shown in FIG. 12A. The control unit 150 assigns the characters to the sub keys as shown in part (a) or (b) of FIG. 4 and assigns tones to the sub keys arranged around the character sub keys. The control unit 150 can configure the sub keypad such that at least one final is assigned to a sub key surrounded by the sub keys assigned the tones. If a drag is detected on the sub keypad, the control unit 150 can input the finals along with the tones corresponding to the sub keys in selection order of finals. That is, if a touch is detected at a main key and then a drag to the sub key is detected, the control unit 150 can input the initial m, the final a, and the tone □ in sequential order.

Although the sub keypad is configured with the character sub keys and tone sub keys arranged irregularly, the control unit 150 can discriminate between the drags to the character and tone keys. That is, since the drag starting from the sub key assigned i, a, or e to the sub key assigned to a sub key assigned a tone is directed outward, it is possible to identify the drag from the sub key assigned i, a, or e to the sub key assigned a tone is discriminated from the drag to the sub key assigned a character. Since i, a, or e cannot follow er, n, or ng; the drag from the sub key assigned er, n, or ng to the sub key assigned a tone is discriminated from the drag to the sub key assigned a character. Also, since the finals that can follow u or ü (e.g., a and e) are not adjacent to u or ü (i.e., distant from u or ü by means of at least one interposed sub key in the sub keypad), the drag from the sub key assigned u or ü to the sub key assign a tone is discriminated from the drag to the sub key assigned a character.

However, if a drop event occurs after the detection of the drag from the sub key assigned ü to the sub key assigned a, the control unit 150 can regard this as the tone input. In the state where the sub keypad is displayed as shown in FIG. 12A, the control unit 150 can input üan according to the drag passing the sub keys assigned ü, a, and n in sequence.

The control unit 150 also can display the sub keypad composed of sub keys assigned the respective characters and tones as shown in FIG. 12B. Here, the control unit 150 can display the sub keys assigned the characters and tones discriminately in the sub keypad. That is, the sub keypad includes a first sub keypad composed of the sub keys assigned at least one final and a second sub keypad composed of the sub keys assigned respective tones and arranged with a predetermined distance from the main keypad. If a sub key assigned a final is selected from the first sub keypad and a sub key assigned a tone from the second sub keypad, the control unit 150 can input the selected final with the selected tone mark. The controller 150 can assign the characters to the sub keys as shown in part (a) or (b) of FIG. 4 or in a different pattern from that of parts (a) and (b) of FIG. 4. For example, if a touch at a main key assigned n, a drag to the sub key assigned a, and a tap to the sub key assigned the tone □ are detected in sequence, the control unit 150 can input the initial m, the final a, and shangsheng corresponding to the tone mark □ in sequence.

The control unit 150 also can display the sub keypad including the sub keys assigned characters and the sub keys assigned tones as shown in FIG. 12C. Here, the control unit 150 can display the character sub keys and the tone sub keys discriminately. That is, the sub keypad can include a first sub keypad including at least one sub key assigned at least one final and a second sub keypad including the sub keys assigned the tones, the second key being arranged with a predetermined distance from the main keypad. If a sub key assigned a final is selected from the first sub keypad, the control unit 150 can input the selected final. Afterward, if a drag to the second keypad is detected, the control unit 150 checks the tone assigned to the sub key at which the drag has stopped and inputs the tone in combination with the selected final. The control unit 150 can assign the characters to the sub keys as shown in part (a) or (b) of FIG. 4 or in a pattern different from that of parts (a) and (b) of FIG. 4. That is, if the touch at the main key assigned m, the drag to the sub key assigned a, and the drop at the tone mark □ are detected in sequence (i.e., touch, drag, and drop events are detected in sequence), the control unit 150 can input the initial m, the final a, and the shangsheng corresponding to □ in combination among each other.

When the character sub keys and the tone sub keys are provided in a mixed manner, the control unit 150 can display the character keys as shown in part (a) or (b) of FIG. 4. However, when the character sub keys and the tone sub keys are provided in a discriminated manner, the control unit 150 can assign the characters to the sub keys as shown in part (a) or (b) of FIG. 4 or in a pattern different from those of parts (a) and (b) of FIG. 4.

The control unit 150 also can display the sub keypad including the sub keys assigned the characters as shown in FIG. 12D. The control unit 150 can assign the characters to the sub keys as shown in part (a) or (b) of FIG. 4 or in a pattern different from those of parts (a) and (b) of FIG. 4. The control unit 150 also can activate the main keys of the main keypad to allow inputting a tone. That is, the control unit 150 can assign a tone to at least one other main key distant from the main key in the main keypad. Afterward, if a drag to other main keys is detected, the control unit 150 selects the tone corresponding to the main keys in selection order and inputs the selected tone in combination with the selected other character. That is, if the touch at the main key assigned m, the drag to the sub key assigned a, and the drop at the main key assigned □ are detected in sequence, the control unit 150 inputs the initial m, the final a, and the shangsheng corresponding to the tone mark □ in combination with each other.

Although not depicted in a drawing, the control unit 150 can display the sub keypad including the sub keys assigned characters and tones. The control unit 150 can assign the tones to the sub keys at the right side of the sub keys assigned the finals. In this manner, the sub keys assigned the finals and the sub keys assigned the tones are arranged alternately in a rightward direction. Here, the control unit 150 assigns the tones to the sub keys arranged at the right side of the sub keys assigned the finals i, a, and e.

Although the description has been directed to the Chinese character input system, the present disclosure is not limited thereto. That is, the present disclosure can be applied to other language input systems. For example, the method according to the present disclosure can be applied to a Korean language input system. In this situation, if a touch is made to a main key assigned a consonant, the terminal can display the sub keypad including sub keys assigned at least one vowel around the corresponding main key. The terminal also can be configured to input Korean text using the main and sub keypads.

Although the description has been directed to a terminal equipped with a touchscreen displaying the main and sub keypads, the present disclosure is not limited thereto. For example, the character input method of the present disclosure can be applied to a terminal equipped with a keyboard having the main keys arranged mechanically and a touchpad provided separate from the keyboard. In this situation, when a main key is selected in the text input mode, the terminal inputs the character assigned to the corresponding main key and displays the sub key pad corresponding to the main key on the touchpad. If a drag is made and then stops at a specific sub key or another main key is selected on the keyboard, the terminal can input the character assigned to the corresponding sub key or the other character assigned to another main key.

As described above, the character input method and apparatus of the present disclosure is implemented such that the characters combinable with each other are arranged adjacent on the main keypad and/or sub keypad so as to facilitate inputting text. Also, the character input method and apparatus of the present disclosure facilitate inputting characters by presenting characters associated with the previously selected character using the main and sub keypads. With these features, the character input method and apparatus of the present disclosure is capable of improving user convenience and terminal utilization.

Although exemplary embodiments of the present disclosure have been described in detail hereinabove, it should be clearly understood that many variations and/or modifications of the basic inventive concepts herein taught which may appear to those skilled in the present art will still fall within the spirit and scope of the present disclosure, as defined in the appended claims.

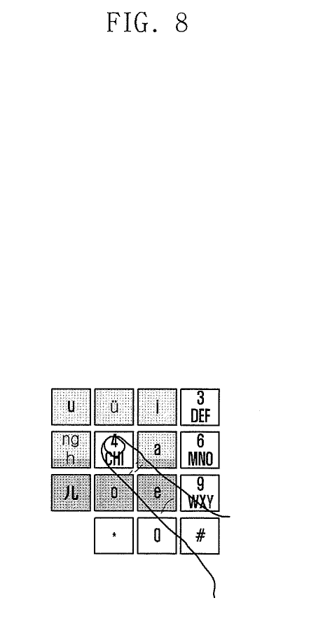

Although the description is directed to embodiments where the main keypad is configured in the form of the QWERTY keypad similar to the universal keyboard, the present disclosure is not limited thereto. For example, the present disclosure can be applied to a terminal implemented with a 3×4 main keypad as shown in FIG. 8.

What is claimed is:

1. A character input method for a terminal, comprising:
displaying a main keypad including a plurality of main keys in text input mode;
entering, when a touch is detected at one of the main keys, a character assigned to the main key at which the touch is made;
displaying a sub keypad around the main key, the sub keypad including a plurality of sub keys assigned characters combinable with the entered character; and
entering, when the touch is dragged to one of the sub keys, the character assigned to the sub key to which the touch is dragged.

2. The character input method of claim 1, further comprising hiding, when the touch is released at a key or dragged out of the sub keypad, the sub keypad on the main keypad.

3. The character input method of claim 1, further comprising:
entering, when the touch is dragged to a second main key, the character assigned to the another main key; and
displaying the sub keypad around the second main key.

4. The character input method of claim 1, further comprising entering, when the touch is dragged from the sub key and back to the same sub key, the characters of the main and sub keys repeatedly.

5. The character input method of claim 1, wherein the character assigned to the main key is one of consonants and vowels, and the character assigned to the sub key is one of the vowels.

6. The character input method of claim 1, wherein the character assigned to the main key is one of Chinese pinyin symbols, and the character assigned to the sub key is one of h, finals, and tones.

7. The character input method of claim 1, wherein the character assigned to the main key is one of Chinese Zhuyin fuhao phonetic symbols, and the character assigned to the sub key is one of finals and tones of the Chinese phonetic symbols.

8. The character input method of claim 1, wherein the sub keypad comprises the sub keys arranged in 3×3 configuration.

9. The character input method of claim 1, further comprising reconfiguring the sub keypad to have the sub keys assigned different characters according to the character entered by the selected sub key, while maintaining the selected sub key.

10. The character input method of claim 1, wherein entering the character assigned to the sub key comprises:
displaying, when one of the sub keys is assigned two characters, at least two candidate words obtained by combining the character assigned to the main key and the characters assigned to the sub key; and
inputting, when one of the candidate words is selected, the selected candidate word.

11. A character input apparatus of a terminal, comprising:
a touchscreen configured to display a main keypad comprising a plurality of main keys in text input mode; and
a control unit configured to:
enter, when a touch is detected at one of the main keys, a character assigned to the main key at which the touch is made;
display a sub keypad around the main key, the sub keypad including a plurality of sub keys assigned characters combinable with the entered character; and
enter, when the touch is dragged to one of the sub keys, the character assigned to the sub key to which the touch is dragged.

12. The character input apparatus of claim 11, wherein the control unit hides the sub keypad on the main keypad when the touch is released at a key or dragged out of the sub keypad.

13. The character input apparatus of claim 11, wherein, when the touch is dragged to another main key, the control unit enters the character assigned to the another main key and displays the sub keypad around the another main key.

14. The character input apparatus of claim 11, wherein the control unit enters the characters of the main and sub keys repeatedly, when the touch is dragged from the sub key and back to the same sub key.

15. The character input apparatus of claim 11, wherein the character assigned to the main key is one of consonants and vowels, and the character assigned to the sub key is one of the vowels.

16. The character input apparatus of claim 11, wherein the character assigned to the main key is one of Chinese pinyin symbols, and the character assigned to the sub key is one of h, finals, and tones.

17. The character input apparatus of claim 11, wherein the character assigned to the main key is one of Chinese Zhuyin fuhao phonetic symbols, and the character assigned to the sub key is one of finals and tones of the Chinese phonetic symbols.

18. The character input apparatus of claim 11, wherein the sub keypad comprises the sub keys arranged in 3×3 configuration.

19. The character input apparatus of claim 11, wherein the control unit reconfigures the sub keypad to have the sub keys assigned different characters according to the character entered by the selected sub key, while maintaining the selected sub key.

20. The character input apparatus of claim 11, wherein the control unit displays, when one of the sub keys is assigned two characters, at least two candidate words obtained by combining the character assigned to the main key and the characters assigned to the sub key, and inputs, when one of the candidate words is selected, the selected candidate word.
